(19) United States
(12) Patent Application Publication
(10) Pub. No.: US 2006/0102212 A1
(43) Pub. Date: May 18, 2006

(54) Pressure washer

(76) Inventors: Jeremy D. Leasure, Jackson, TN (US); Kim C. Reeves, Lexington, TN (US); Randy Anderson, Jackson, TN (US)

Correspondence Address: THE BLACK & DECKER CORPORATION, 701 EAST JOPPA ROAD, TW199, TOWSON, MD, 21286, US

(21) Appl. No.: 10/993,219

(22) Filed: Nov. 19, 2004

Related U.S. Application Data
(60) Provisional application No. 60/525,526, filed on Nov. 26, 2003.

(51) Int. Cl. B08B 3/12

(52) U.S. Cl. 134/172

(57) ABSTRACT

The present invention is directed to a pressure washer having an internal mounting and outer clam shell housing. Accordingly, a pressure washer includes an engine for mechanically coupled to a pump. An internal mounting assembly including a folded portion is disposed generally between the engine and the pump so as to mount/support the engine and pump structure. In embodiments, various axle mounting structures such as a unitary axle bracket, a separate axle bracket, or the like is integrated with a folded main mounting into the mounting assembly. An axle assembly having at least two spaced apart wheels pivotally mounted to an axle which extends through the internal mounting axle bracket is included in the pressure washer. A generally U-shaped frame member is secured to at least one of the internal mounting/engine. The U-shaped frame member is implemented to support the pressure washer in a tripod like fashion with the wheels when disposed on a support surface. A plastic outer housing is utilized to substantially encompass the pump so as to prevent damage, minimize the need for refinement of the internal mounting assembly (for ascetics, for corrosion protection, finishing), and the like. Preferably, the outer housing implements clam shell portions with corresponding mechanical interconnects to mechanically secure the various sections. A fastener may be implemented to secure the shell portions generally adjacent a side opposite the mechanical interconnects.

### CROSS REFERENCE

The present application claims priority under 35 U.S.C. §119(e) to U.S. Provisional Patent Ser. No. 60/525,526, entitled: Pressure Washer, filed on Nov. 26, 2003, which is hereby incorporated in its entirety.

### FIELD OF THE INVENTION

The present invention relates to the field of power tools and particularly to a mounting and frame configuration for a power washer.

### BACKGROUND OF THE INVENTION

Typically, portable engine powered devices such as generators, power washers compressors, power paint sprayers and the like are mounted on frame structures for transport between work sites. The difficulties associated with manufacturing these frames include the complexity of the mounting structure, the expense of providing an axle assembly and the configuration of the protecting coverings. The preceding considerations may significantly increase manufacturing time and increase component expense.

For instance, pressure or power washers typically are either a horizontal type professional washers or vertical washers. Vertical washers are usually preferred by home owners and do-it-yourself consumers due to the vertical washer's relatively small storage footprint. Typically, vertical washers include an exposed housing structure which at least partially encloses various washer components. In order to accomplish this function, a housing usually undergoes a complex manufacturing process including multiple stampings and painting or coatings for exposed surfaces. These procedures increase expense.

In addition to consumer demands, vertical power washers take up less retail space. Further retail concerns include the ability to place the washer on a shelf or stack the product for storage such as when removed from packaging for display within a retail environment as opposed to consuming valuable floor space.

Therefore, it would be desirable to provide a mounting and frame configuration for a power washer.

### SUMMARY OF THE INVENTION

Accordingly, the present invention is directed to a pressure washer apparatus and a method for assembling a pressure washer apparatus.

In an aspect of the invention, a pressure washer is disclosed. In accordance with the present aspect, a pressure washer includes an engine for mechanically coupled to a pump. An internal mounting assembly including a folded portion is disposed generally between the engine and the pump so as to mount/support the engine and pump structure. In alternative embodiments, a unitary axle bracket, a separate axle bracket, or the like is integrated with a folded main mounting. An axle assembly having at least two spaced apart wheels pivotally mounted to an axle which extends through the internal mounting axle bracket is included in the pressure washer. A generally U-shaped frame member is secured to at least one of the internal mounting/engine. The U-shaped frame member being configured to support the pressure washer in a tripod like fashion with the wheels when disposed on a level support surface. A plastic outer housing is configured so as to substantially encompass the pump so as to prevent damage and the like.

In an additional aspect of the invention, a method of manufacturing a pressure washer includes forming an internal mounting assembly. Optionally, a frame member may be attached to the internal mounting prior to assembling a first shell portion. A second shell portion is assembled such as by securing corresponding mechanical interconnects included on the shell portions. A fastener such as a screw or bolt is implemented to secure the shell portions on a side opposite the corresponding mechanical interconnects.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view of a of a pressure washer having an outer housing in accordance with an aspect of the present invention;

FIG. 2 is an exploded view of a pressure washer in accordance with the present invention;

FIG. 3 is a partial exploded view of an axle assembly and internal mounting assembly;

FIG. 4 is an exploded view of an outer housing including a first shell portion and a second shell portion; and

FIG. 5 is a flow diagram illustrating a method of assembling a pressure washer having an internal mounting assembly and an outer housing formed of shell portions.

### DETAILED DESCRIPTION OF THE INVENTION

Reference will now be made in detail to the presently preferred embodiments of the invention, examples of which are illustrated in the accompanying drawings. It is to be appreciated that corresponding reference numbers refer to corresponding structures.

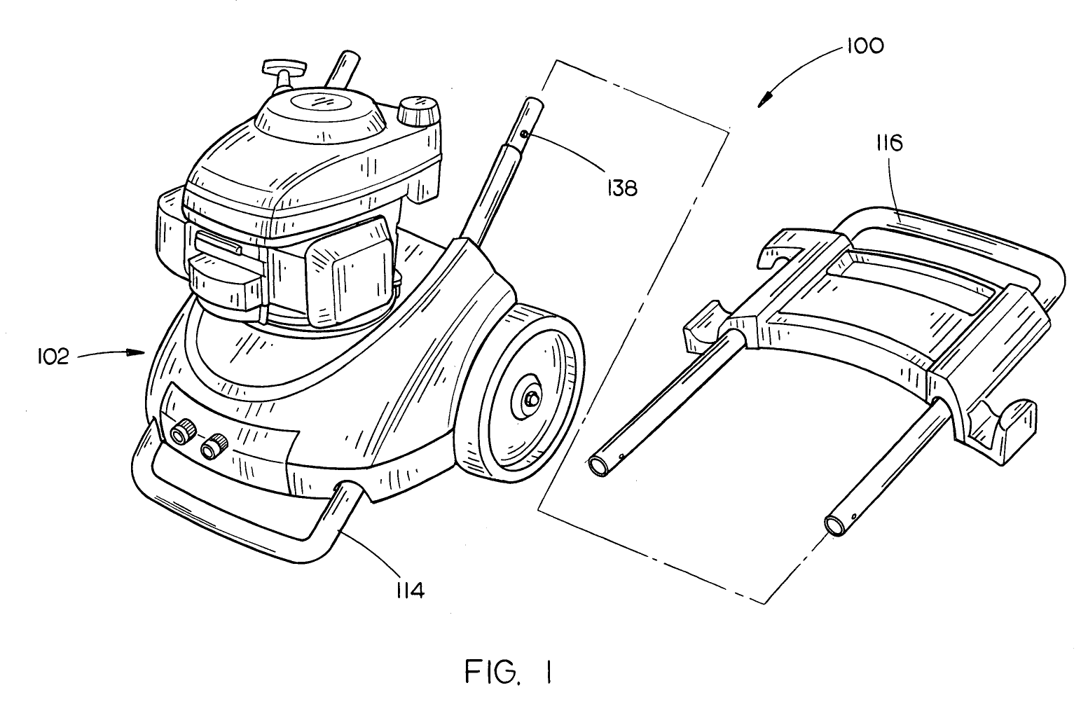

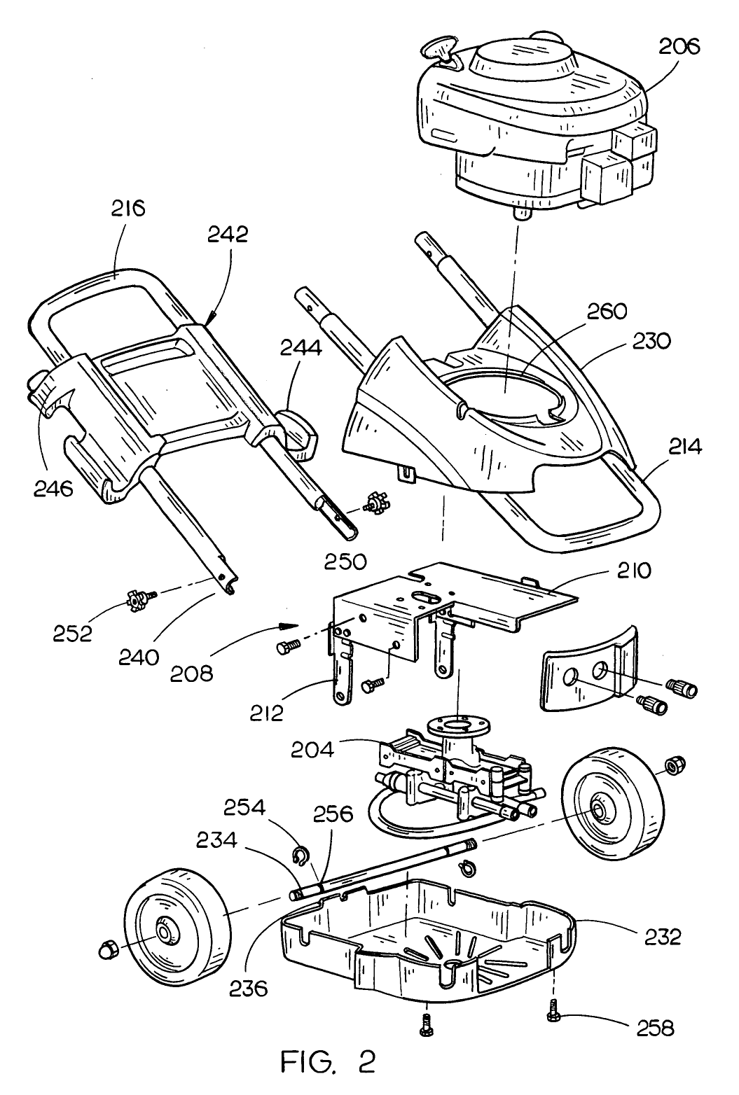

Referring to FIGS. 1 and 2, a pressure washer 100 in accordance with an aspect of the present invention is discussed. In the present embodiment, the pressure washer 100 includes a plastic outer housing 102 for substantially encompassing various washer components such as a pump 204 for pressurizing fluid from a first lower pressure to a higher pressure. In the present embodiment, the pressure washer is a vertical washer wherein the pump is disposed generally below an engine 206, as generally orientated in FIG. 1. The pressure washer 200 implements an internal mounting assembly 208 for providing a mounting for various pressure washer components such as the engine, pump and the like. In the current embodiment, the internal mounting assembly 208 includes a main mounting 210 being formed as a folded structure such as a piece of bendable sheet steel or the like. For example, generally opposing sides of the main mounting are bent generally perpendicular to a generally flat surface of the main mounting 210. Preferably, the main mounting is generally secured between the engine 206 and the pump 204. Disposing a portion of the internal mounting between the engine and pump permits securing the engine/pump to the internal mounting assembly, securing the engine, the internal mounting, and pump together such as via a series of fasteners extending from the engine through the internal housing to the pump such that the components are secured together.

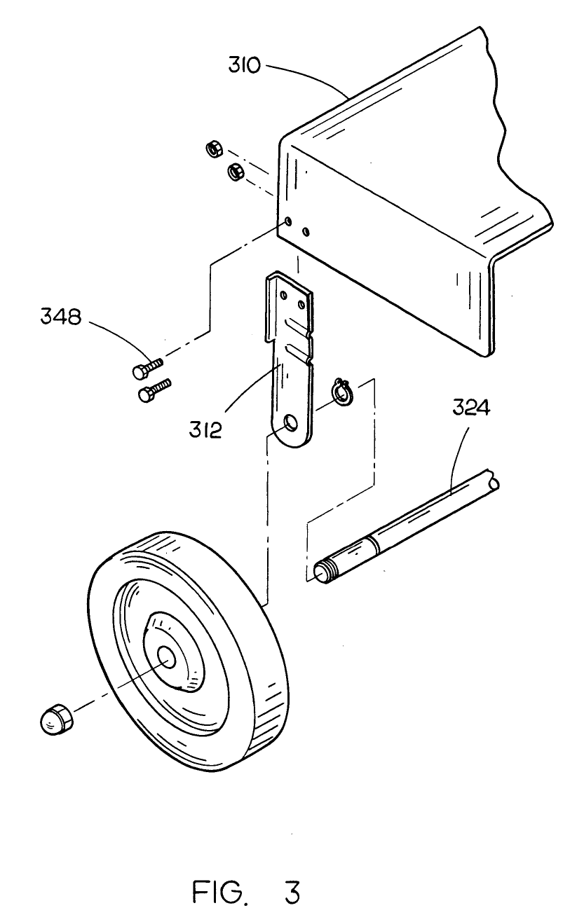

Referring to FIG. 3, in the present embodiment, generally opposing axle brackets 312 9one bracket is referenced) are secured via fasteners 348 to the main mounting 210. Suitable fasteners include screws, bolts and nuts, welds, and the like. In an advantageous embodiment, two axle brackets, of a common bracket type, are implemented on opposing ends of an axle 324. In additional embodiments, at least a portion of an axle bracket may be received in recess or mechanical interlock included in a outer housing (discussed below). Implementing a common axle bracket may promote increased manufacturing efficiency and simplify part replacement. In further embodiments, an internal mounting is unitarily formed with axle brackets such as by folding a sheet metal mounting with an aperture for receiving an axle. In the previous example, the internal housing may be formed as a partial enclosure having a generally flat side, with an appropriate aperture for permitting passage of an engine drive shaft, disposed between the engine/pump, e.g., a three sided enclosure. In an advantageous embodiment, integrated axle brackets at least partially enclose the pump so as to prevent inadvertent damage or the like. Those of skill in the art will appreciate various other folded structures may be formed such as a four-sided partial enclosure, or the like for enclosing the pump, securing various components, and the like. Furthermore, an axle bracket may be formed as a folded portion such as a folded tab unitary with the main mounting extending generally toward the pump. In further embodiments, an internal mounting assembly may be stamped with a series of ribs or the like adjacent the interface of a side so as to increase rigidity.

A generally U-shaped frame member 114 is secured to at least one of the engine 106 or the internal mounting assembly such as the main mounting 110. For instance, the U-shaped frame member may be secured along generally opposing sides of a main internal mounting (e.g. along bracket flaps or portions of a mounting assembly) via a series of fasteners. The generally U-shaped frame member may include an intermediate segment such that the terminal portions of the frame extend substantially equal or slightly greater than the height of the engine and adjacent the engine in order to prevent inadvertent damage such as may occur from an overhead obstruction, i.e. when being placed on a retail shelf or the like. In further examples, the frame member is substantially planer. Preferably, the cross member of the frame member is constructed so as to act as a foot such that the pump and engine are substantially level when disposed on a flat surface, i.e., a tripod with included wheels. For instance, the cross member may include an elastomeric or flexible pad or contact so as to minimize vibrations, prevent support surface marring, or the like. A handle member such as a generally U-shaped handle member 116 is coupled to the frame member 114 adjacent a side of the engine opposite the pump. Preferably, the frame members 214 and the handle member 216 are formed of metallic cylindrical tubing, such as steel tubing. In further instances, the shape and the composition of the frame members may be varied as desired. For instance, the handle member may be formed from oval shaped tubing, for user comfort.

A securing mechanism secures a terminal portion of the frame member to a corresponding terminal portion of the handle member. Referring to FIG. 1, in the present embodiment, a biased pin such as a spring clip 138 having a pin end disposed in at least one of the frame member or the handle member for extending through an aperture in the member in which the spring clip is contained into a corresponding aperture in the opposing member which telescopes over the portion containing the securing mechanism. Other suitable securing mechanisms include a through bolt and a threaded hand grip knob, fasteners, bolts and butterfly nuts, a linchpin, a hair pin and through pin combination, bayonet locks, set bolts, spring biased pins, clamp locks, a biased ball bearing, and the like for permitting releasable securing of the handle/frame members. As may be observed in FIG. 2, in a further aspect, at least one of the terminal portions of the handle/frame members include substantially C-shaped cross-section 240, so as to permit close contact between the corresponding ends when secured. In the foregoing manner, the handle portion may be folded over the mechanical components during storage. In an additional instance, a cross-bracket 242 is coupled to the handle member. A cross-bracket is included to secure various accessories during transport. For instance, a cross-bracket may include a hook 244 for hanging a pressure hose, a pressure washer wand holder 246 (i.e., a series of contoured extensions configured to hold a pressure washer wand) such as a first contoured extension constructed to support the wand and a second extension into which the wand is configured to snap fit or frictionally secure. A basket portion or a series of recesses may be included to retain various items such as detergent bottles, nozzle tips, and the like.

Referring to FIG. 2, an axle assembly 118 is included in the power washer. In the present embodiment, the axle assembly includes a pair of generally opposing wheels, individually, 120 and 122 mounted to an axle 124 which extends through the mounting brackets/side flaps of a main mounting. In the present embodiment, the wheels are formed of rigid plastic in further embodiments, pneumatic wheels may be implemented. A capture or cap 126 having a mechanical locking structure, such as a threaded recess for receiving a threaded portion of the axle, a frictional locking or capture device, may be implemented to secure the wheels in place. In a further instance, the axle may be formed to retain internal mounting assembly brackets in a secured position such as by including a central portion of the axle having a larger diameter, utilizing a locking clip such as a C-clip 254 secured to a groove in the axle 256 or the like.

Referring now to FIGS. 1, 2, and 4, an outer housing 102 is included to substantially encompass the pump 204. Preferably, the outer housing is formed of a plastic or polymer type material. Implementing an outer housing may addition protect the various power washer components, allow for an inner housing having a less refined finish or non-aesthetic appearance. For example, the outer housing may be formed of acrylonitrile butadiene styrene (ABS) or the like having suitable rigidity, dent resistance, and workability (e.g., efficient blow-molding or the like). In the present embodiment, the outer housing is formed as a clam shell with a first portion and a second portion. Those of skill in the art will appreciate that addition shell portions or outer housing sections may be included as well based on manufacturing, repair issues, increase aesthetics, or the like. For example, a separate faceplate section may be included adjacent a quick connect for a common water supply or a quick connect for attaching a high pressure outlet hose.

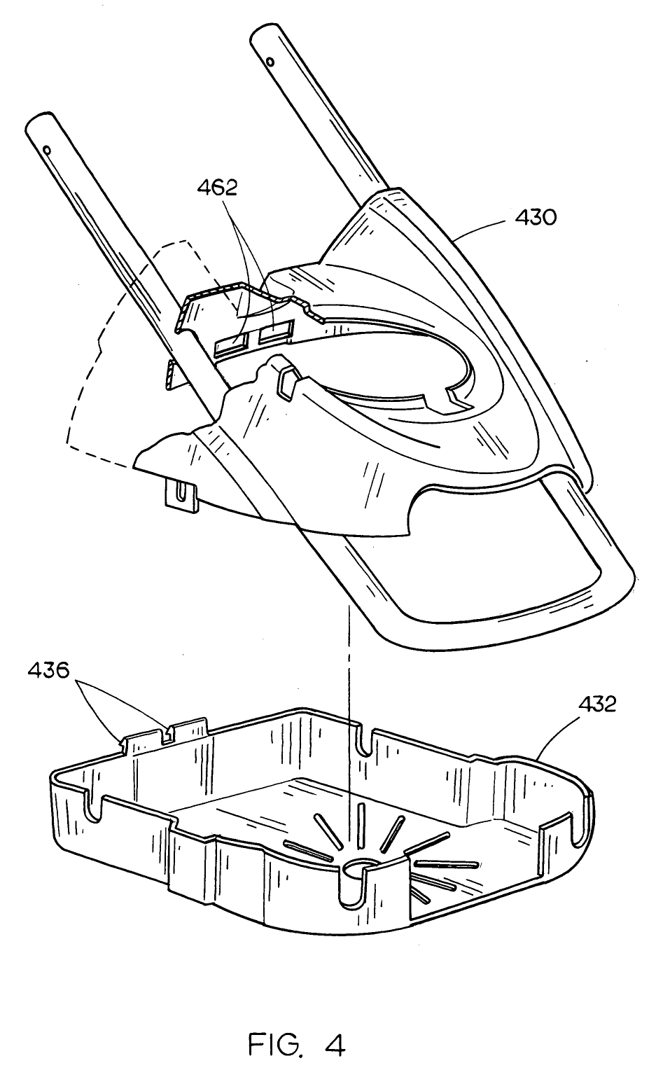

Referring to FIGS. 2 and 4, in the present example, the first and second shell portions 230, 232, respectively, include, individually, corresponding mechanical interconnects for forming a pseudo hinge or connection to permit attachment of a second shell portion to the shell portion previously attached to a partially assembled power washer. As may be best observed in FIG. 4, for example, a first shell portion 430 may include a catch, (e.g., a recess or aperture) for receiving a latch, (e.g., a wedge shaped protrusion 436 or tab) included on a second shell portion 432 such that the shell portions may be secured along a side (e.g., a side adjacent an axle) with fasteners 258 (one fastener is referenced in FIG. 2) utilized to secure the portions on a generally opposite side. Those of skill in the art will appreciate that various mechanical interconnect structures may be implemented without departing from the scope and spirit of the present invention. In the foregoing manner, the amount of fasteners need to secure an outer housing, may be reduced (over a device having fasteners adjacent major corners, i.e., at each corner of a rectangular interface) while providing a secure connection. Furthermore, including a corresponding catch and latch system or the like mechanical interconnect adjacent the axle permits efficient removal of a portion of the outer housing 232 for a user positioned generally opposite the axle, in this manner the washer may be tilted on its wheels to remove a section of the outer housing to gain access to contained components.

In an advantageous example, an outer housing is configured to assemble (subsequently) about a pre-connected frame member 214. In a first example, an aperture is included in a shell portion such that a frame member may be extended through the opening with the closed end of the U-shaped frame member passing between at least two opposing shell portions. In a further instance, the seam between the first and second shell portions may be configured such that a frame section does not have to be inserted through an aperture included in one of the shell portions (i.e., opposing shell portions contour about the frame member to permit simplified assembly). In the previous embodiment, a first outer housing shell portion may be secured at least partially over the internal housing having a frame member previously attached prior to assembly of the engine. In the foregoing manner, a central aperture 260 included in the first frame portion may be minimized to permit passage of the engine mountings, the engine drive shaft, or the like without having to construct the outer shell to accommodate a pressure washer having a preassembled engine.

Outer housing portions may additionally include a mechanical interconnect about the interface of the shell portions. For example, a corresponding lip and recess may be included to increase rigidity about the interface to minimize deflection of one shell portion relative to an opposing shell portion. In further embodiments, an outer housing is formed with a hand hold for grasping the outer housing, such as when lifting the power washer. For example, a recess configured with a protrusion may be included to permit a user to easily grasp the pressure washer. Additionally, hand-holds may be configured to aid lifting of the pressure washer by two users such as when the washer is lifted between two people disposed on the sides of the washer (i.e., along the sides generally containing the wheels). In additional examples, an outer housing is configured with a drain hole for permitting potentially leaked liquid to escape. The drain hole is preferably included on a outer housing section adjacent the wheels to permit drainage. Furthermore, additional apertures may be included to aid cooling of the pump components.

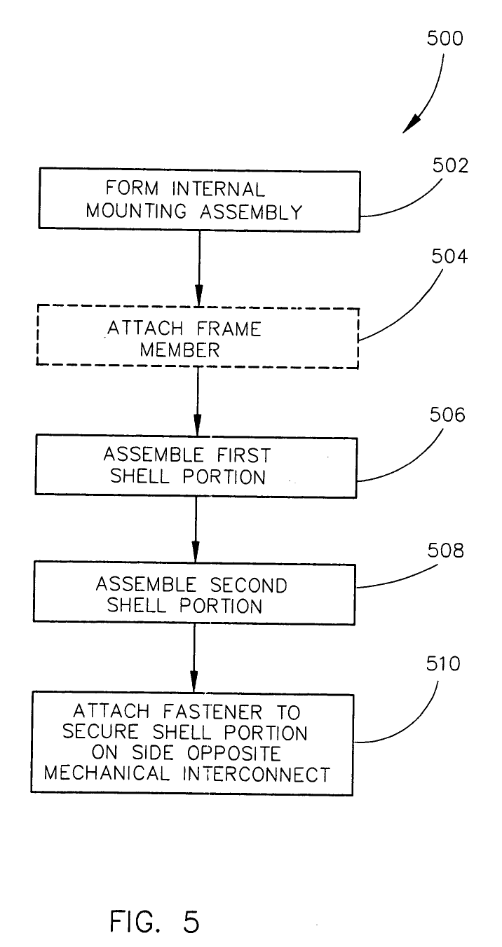

With reference to FIG. 5, a method of manufacturing a pressure washer 500 is discussed. Initially, an internal mounting assembly is formed 502. An internal mounting assembly may include a folded main mounting such as formed from sheet metal. Forming a mounting assembly may include securing separate axle brackets via a fastener to a main mounting. Alternatively, an axle bracket may be unitary with a main mounting such as by including an aperture (for accepting an axle) in a folded flap or tab formed in a main housing.

A first clam shell housing portion is assembled 506 to at least partially encompass the internal mounting assembly. Those of skill in the art will appreciate that additional components may be preassembled as well. Preferably, the first clam shell portion is assembled 506 prior to installation of a engine so as to minimize the size of an aperture in the first shell portion for permitting passage of the engine drive shaft and the like and to substantially enclose the internal mounting. In a further step, a tubular frame member may be attached 504 to the internal mounting prior to assembly of the first clam shell portion. Attaching a frame member prior to assembly of the first clam shell included in the outer housing may permit efficient access to fasteners implemented to secure the tubular frame to the mounting. Additionally, at least one first clam shell member and a second clam shell member may be constructed such that the interface of the two shell members is configured to surround the tubular frame member thereby eliminating the requirement of inserting the frame member through an aperture included in one of the shell portions of the outer housing.

In the current method, the second outer housing shell portion is assembled 508 to the first shell portion such as by connecting corresponding mechanical interconnects included on the first and second shell portions. For example, during assembly of the second shell portion, a generally wedge shaped latch included on the second shell portion may be inserted into a corresponding aperture included in the first shell portion generally along a side of the housing. Assembling the first and second outer housing shell portions via a mechanical connection may reduce the quantity of fasteners required to secure the shell portions together.

In a further step, a fastener such as a screw, a bolt and nut, a bolt received in a recess included in a shell portion, or the like is attached 510 to fasten the first and second housing shell portions on a side generally opposite the mechanical interconnect side.

Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A pressure washer, comprising:
an engine for providing mechanical energy;
a pump, operatively coupled to the engine, the pump for pressurizing fluid from a first lower pressure to a higher pressure;
an internal mounting assembly, having at least one side secured between the engine and the pump, the mounting assembly being configured with at least one bracket extending generally away from the engine;
an axle assembly, pivotally mounted to the at least one bracket, the axle assembly including at least two spaced apart wheels for facilitating rolling transport;
a generally U-shaped frame member, secured to at least one of the engine or internal mounting assembly, the generally U-shaped frame member having a cross member and terminal leg portions, the U-shaped frame member being configured for supporting the pressure washer on a support surface with the at least two wheels; and
an outer housing, formed of a plastic material, the outer housing being configured to substantially encompass the pump,
wherein the internal mounting assembly is formed as a folded structure.

2. The pressure washer of claim 1, wherein the generally U-shaped frame member is formed of tubing.

3. The pressure washer of claim 1, further comprising a generally U-shaped handle member formed to interconnect with the generally U-shaped frame member adjacent a side of the engine opposite the pump.

4. The pressure washer of claim 3, further comprising a securing mechanism for securing the generally U-shaped handle member to the generally U-shaped frame member.

5. The pressure washer of claim 4, wherein a securing mechanism is selected from the group consisting of a bolt and threaded knob, a biased ball bearing, and a biased pin.

6. The pressure washer of claim 1, wherein the outer housing is formed as a clam shell.

7. The pressure washer of claim 6, wherein the outer housing includes a mechanical interconnect for mechanically coupling the clam shell portions.

8. The pressure washer of claim 7, wherein the portion of the clam shell generally opposite the engine is constructed to be connected subsequent to the connection of the generally U-shaped frame member.

9. The pressure washer of claim 1, wherein the outer housing includes a hand-hold for grasping the outer housing.

10. The pressure washer of claim 1, further comprising a handle member configured to fold-over at least one of the engine or the outer housing for storage.

11. The pressure washer of claim 1, wherein the axle assembly is configured to retain the at least one bracket in a fixed position with respect to the axle assembly.

12. The pressure washer of claim 1, wherein at least one of the generally U-shaped frame member and the handle member includes a generally C-shaped cross-sectional end for securing to a generally circular shaped cross sectional end of the corresponding member.

13. The pressure washer of claim 1, further comprising a generally U-shaped handle member and a cross-bracket, coupled to the handle member, the cross-bracket including at least one of a pressure washer wand holder or a hose hook.

14. The pressure washer of claim 1, wherein the outer housing includes a drain hole on a side generally opposite the engine.

15. The pressure washer of claim 1, wherein the at least one internal mounting assembly includes two opposing brackets secured via a fastener to a main internal mounting.

16. A pressure washer, comprising:
an engine for providing mechanical energy;
a pump, operatively coupled to the engine, the pump for pressurizing fluid from a first lower pressure to a higher pressure;
an internal mounting, having at least one side secured between the engine and the pump, the mounting being configured with at least one side bracket extending generally away from the engine, the internal mounting being formed from a unitary piece of folded material;
an axle assembly, pivotally mounted to the at least side one bracket, the axle assembly including at least two spaced apart wheels for facilitating rolling transport;
a frame member, secured to at least one of the engine or internal mounting, the frame member having a cross member and terminal leg portions, the frame member being configured for supporting the pressure washer on a support surface with the at least two wheels; and
an outer plastic clam shell housing formed of shell portions, the outer housing being configured to substantially encompass the pump,
wherein the internal mounting is configured to substantially encompass the pump.

17. The pressure washer of claim 16, wherein the frame member is formed of tubing.

18. The pressure washer of claim 16, further comprising a handle member formed to interconnect with the frame member adjacent a side of the engine opposite the pump.

19. The pressure washer of claim 18, further comprising a securing mechanism for securing the handle member to the frame member.

20. The pressure washer of claim 19, wherein a securing mechanism is selected from the group consisting of a bolt and threaded knob, a biased ball bearing, and a biased pin.

21. The pressure washer of claim 16, wherein the outer housing includes a mechanical interconnect for mechanically coupling the clam shell portions together.

22. The pressure washer of claim 16, wherein the portion of the clam shell generally opposite the engine is constructed to be connected subsequent to the connection of the frame member.

23. The pressure washer of claim 16, the portion of the clam shell generally opposite the engine is secured to the clam shell portion adjacent the engine via a corresponding catch and latch.

24. The pressure washer of claim 16, wherein the outer plastic clam shell housing includes a drain hole on a side generally opposite the engine.

25. A method of manufacturing a pressure washer, comprising:
forming an internal mounting assembly including a bracket for coupling an axle assembly thereto;
assembling a first clam shell outer housing portion to at least partially encompass the internal mounting assembly;
assembling a second clam shell outer housing portion to the first clam shell outer housing portion so as to substantially encompass a pump included in the pressure washer, the first and second clam shell outer housing portions being configured with corresponding mechanical interconnects for securing the first and second clam shell outer housing portions to each other along a side of the housing;
attaching a fastener to fasten the first and the second clam shell outer housing portion to each other on a side generally opposite the mechanical interconnect side.

26. The method of claim 25, where the corresponding mechanical interconnects are a catch and a latch.

27. The method of claim 25, further comprising the step of attaching a tubular frame portion to the internal mounting prior to assembling the first clam shell outer housing portion.
